(19) United States
(12) Patent Application Publication
(10) Pub. No.: US 2020/0329087 A1
(43) Pub. Date: Oct. 15, 2020

(54) RELAYING AND RESTREAMING MEDIA

(71) Applicant: RABBIT ASSET PURCHASE CORP., San Diego, CA (US)

(72) Inventor: Bogdan Alexandru Dinulica, Burlingame, CA (US)

(21) Appl. No.: 16/845,049

(22) Filed: Apr. 9, 2020

Related U.S. Application Data
(60) Provisional application No. 62/831,551, filed on Apr. 9, 2019.

(51) Int. Cl. H04L 29/06; H04L 12/18; H04B 7/15

(52) U.S. Cl. CPC H04L 65/607; H04L 12/1818; H04L 63/0457; H04B 7/15; H04L 65/4076

(57) ABSTRACT

One embodiment of the present disclosure presents a technique for re-streaming captures. The technique includes receiving an encoded capture from a streaming system. The technique further includes receiving a connection request from a client system. The technique also includes determining that the client system exceeds a client system threshold. The technique additionally includes outputting a streaming request to a relay. The technique further includes receiving one or more relay parameters and transmitting the encoded capture to the relay. In the technique, the relay transmits the encoded capture to the client system.

### RELATED APPLICATION

This application claims priority to U.S. Provisional Application No. 62/831,551, filed Apr. 9, 2020, titled RELAYING AND RESTREAMING MEDIA, which is incorporated herein by reference in its entirety.

### TECHNICAL FIELD

This disclosure relates generally to media transmission.

### BACKGROUND

Virtual, electronic chat rooms provide a way for users to receive and transmit data, such as text, video, and/or audio content in a structured manner. For example, a chat room may include one or more user controls that allow a user to control content broadcasted to other users who are also “in” the virtual chat room. For example, a user may select a movie for broadcasting to each member of a chat room. The chat room may then enable each member of the chat room to view the selected video content. As another example, a user may create a message and send the message to some or all of the other users in the chat room. The chat room may then enable some or all of the members of the chat room to view the message.

### BRIEF DESCRIPTION OF THE DRAWINGS

FIG. 1 illustrates an example network environment associated with a virtual-room service system 160, according to various embodiments.

FIG. 2 illustrates an example computing system for capturing, encoding, and transmitting synchronous information to a plurality of destinations (e.g., a plurality of client systems), according to various embodiments.

FIGS. 3A-3H illustrates an example system with system failure and crash resolution, according to various embodiments.

FIGS. 4A-4B illustrate cost comparisons between establishing direct connections between client systems and the streamer system and implementing the system to transfer encoded captures to client systems, according to various embodiments.

FIG. 5 illustrates an example scaling technique for the system 500, according to various embodiments.

FIG. 6 illustrates an example method 600 for adding a relay to the system 200, according to various embodiments.

FIG. 7 illustrates an example method for resolving element malfunctions in the system, according to various embodiments.

FIG. 8 illustrates an example computer system.

### DESCRIPTION OF EXAMPLE EMBODIMENTS

The embodiments disclosed herein are only examples, and the scope of this disclosure is not limited to them. Particular embodiments may include all, some, or none of the components, elements, features, functions, operations, or steps of the embodiments disclosed above. Embodiments according to the disclosure are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

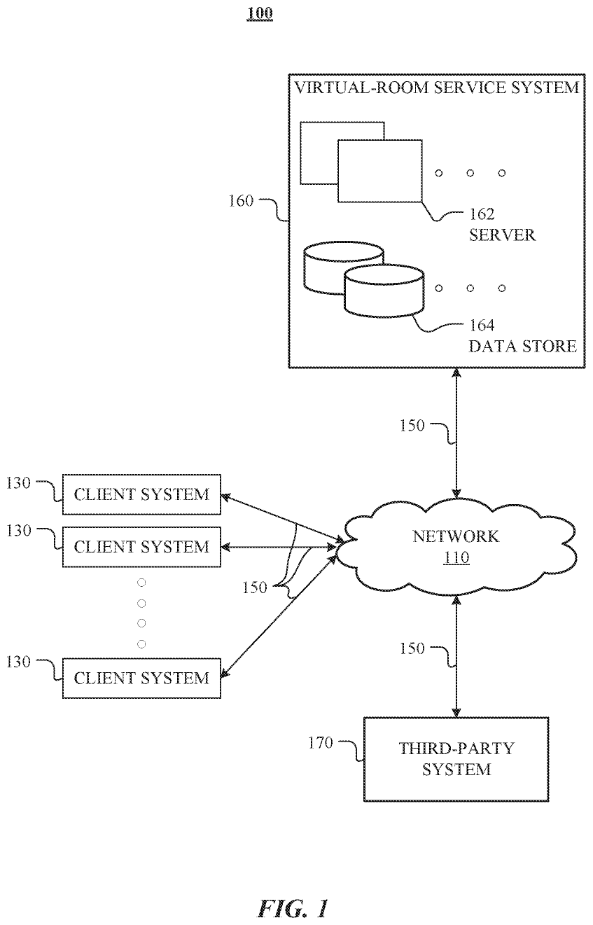

FIG. 1 illustrates an example network environment 100 associated with a virtual-room service system 160, according to various embodiments. Network environment 100 includes multiple client systems 130, virtual-room service system 160, and at least one third-party system 170 connected to each other by a network 110. Although FIG. 1 illustrates a particular arrangement of particular systems, this disclosure contemplates any suitable arrangement of any suitable systems. As an example and not by way of limitation, network environment 100 may include multiple virtual-room service systems 160. As another example, network environment 100 may include multiple third-party systems 170. As another example, virtual-room service system 160 may be physically or logically co-located with each other in whole or in part. Moreover, although FIG. 1 illustrates a particular number of client systems 130, virtual-room service systems 160, third-party systems 170, and networks 110, this disclosure contemplates any suitable number of client systems 130, virtual-room service systems 160, third-party systems 170, and networks 110. As an example and not by way of limitation, network environment 100 may include multiple client system 130, virtual-room service systems 160, third-party systems 170, and networks 110.

This disclosure contemplates any suitable network 110. As an example and not by way of limitation, one or more portions of network 110 may include an ad-hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. For example, network 110 may include one or more networks 110.

In particular embodiments, FIG. 1 may illustrate a method for hosting a virtual-room service system 160 between a plurality of client systems 130. In particular, the virtual-room service system 160 may send room information from a server 162 and/or a data store 164 to one or more client systems 130 via network 110. In addition, the virtual-room service system 160 may control the transmission of third-party content form the third-party system 170 to the client systems 130. As examples only, and not by way of limitation, the following are examples of third-party systems 170 in various embodiments: YOUTUBE, FACEBOOK, SPOTIFY, websites, web pages, HBO GO, SHOWTIME ANYTIME, or any other similar service. One of ordinary skill in the art would realize, however that third-party system 170 could be any type of provider. For example, content may be delivered directly from a live feed of a sporting event or from a handheld device.

In particular embodiments, virtual-room service system 160 may host a “room” for multiple participants to view content from third-party system 170. In particular embodiments, the room is a virtual room where tens, hundreds, thousands, or millions of users may participate with each other, e.g., by watching shared content (such as videos), participating in text or video chats, or both. In further embodiments, each room may be assigned a remote desktop (e.g. server or portion of a server) of virtual-room service system 160. In further embodiments, each remote desktop may be controlled by one or more users in each of the rooms. In particular embodiments, multiple users may control the remote desktop of virtual-room service system 160.

In particular embodiments, client system 130 may access virtual-room service system 160 over network 150 to obtain access to a system, such as, for example and not by way of limitation, a remote desktop, a server, a remote computer, a virtual machine, and so forth. In particular embodiments, after accessing a remote desktop, client system 130 may control the remote desktop. For example, and not by way of limitation, after accessing the remote desktop, client system 130 may use the remote desktop to access YOUTUBE or NETFLIX and further stream content from one or more servers associated with a third-party system 170 (e.g., a server associated with YOUTUBE or NETFLIX). In particular embodiments, multiple other client systems 130 may be connected to the same room as the room associated with the remote desktop accessed by the client system 130. In particular embodiments, all of client systems 130 in a room may simultaneously receive content selected via the remote desktop accessed and controlled by a client system 130. In particular embodiments, server 162 may send third-party content (e.g., textual content, image content, audio content, video content, etc.) of each client system 130 in the room to all of the other client systems 130 in the room. In particular embodiments, the virtual-room service system 160 may track any and all activity that occurs within the room and further log activity data in the data store 164, such as, for example, and not by way of limitation, user preferences, information received and/or transmitted to third-party system 170, and/or any other pertinent information.

In particular embodiments, client system 130 that part of a virtual room may receive one or more streams (e.g., audio streams, video streams, image streams, text streams, etc.) from client systems 130 that are also associated with the virtual room. In particular, the virtual-room service system 160 may receive streams generated by each client system 130 (e.g., audio and/or video streams associated with participant client systems 130 in a room). The virtual-room service system 160 may further stream each from a participant client system 130 to other participant client systems 130 that are associated with the virtual room. Accordingly, a client system 130 that participates in a room may transmit, via virtual-room service system 160, one or more streams to other participant client systems 130 as well as receive, via virtual-room service system 160, one or more streams from the other participate client systems 130 that are participating in the room. For example, a client system 130 may stream content to one or more remote desktops located within a virtual-room service system 160 and the virtual-room service system 160 may re-stream the content to other client systems 130 that are participating in the room associated with the one or more remote desktops. In further embodiments, virtual-room service system 160 may associate each received stream with a client system 130 and may further track user preferences for content based on a stream received from the client system 130 and/or streams requested by and/or transmitted to the client system 130 by the remote desktop associated with the room. The virtual-room service system 160 may store obtained user data (e.g., user preferences, user-generated streams, user-consumed streams, etc.) in data store 164.

In particular embodiments, receiving streams (e.g., audio and/or video streams) from a remote desktop (e.g. server) may include capturing one or more streams (e.g., audio and/or video streams) from the client systems 130, sending the streams to server 162, and subsequently transmitting the streams to each client system 130 in the room. In particular embodiments, capturing streams may include capturing information from client systems 130, such as, for example, and not by way of limitation system parameters of the client system 130 (e.g., types of input/output devices, such as microphones, cameras, etc.). In particular embodiments, the captured streams may include content streamed from third-party system 170. As an example and not by way of limitation, the captured streams may include content streamed from a YOUTUBE video.

Links 150 may connect client system 130, virtual-room service system 160, and third-party system 170 to communication network 110 or to each other. This disclosure contemplates any suitable links 150. In particular embodiments, one or more of links 150 may include one or more of wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic system including any or all of hardware, software, or embedded logic components or a combination of two or more such components that is capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME, APPLE SAFARI or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol/Secure (HTTP/S) request and communicate the HTTP request to the server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files. Such pages may also execute scripts such as, for example and without limitation, those written in JAVASCRIPT, JAVA, MICROSOFT SILVERLIGHT, ADOBE Flash combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, virtual-room service system 160 may be a network-addressable computing system that can host an online social network. Virtual-room service system 160 may generate, store, receive, and send social-networking data, such as, for example, user-profile data, concept-profile data, social-graph information, or other suitable data related to the online social network.

Virtual-room service system 160 may be accessed by the other components of network environment 100 either directly or via network 110. As an example and not by way of limitation, client system 130 may access virtual-room service system 160 using a web browser 132, or a native application associated with virtual-room service system 160 (e.g., a mobile social-networking application, a messaging application, another suitable application, or any combination thereof) either directly or via network 110. In particular embodiments, virtual-room service system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include any or all of hardware, software, or embedded logic components or a combination of two or more such components for carrying out the appropriate functionalities implemented or supported by server 162. In particular embodiments, virtual-room service system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a virtual-room service system 160, or a third-party system 170 to manage, retrieve, modify, add, or delete the information stored in data store 164.

In particular embodiments, virtual-room service system 160 may provide users with the ability to take actions with respect to various types of items or objects supported by virtual-room service system 160. In particular embodiments, virtual-room service system 160 may provide users with the ability to view information from third-party system 170 without client system 130 initiating a separate virtual room. In particular embodiments, virtual-room service system 160 may determine certain information to display from third-party system 170 at a predetermined time and invite users to join an already existing room. For example, every Friday at 7:00 pm the virtual-room service system 160 may stream a horror movie and further may provide a notice to users that Friday at 7:00 pm a horror movie may be streamed. In further embodiments, after logging in to the virtual-room service system 160, if the horror movie has already begun, the virtual-room service system 160 may provide a notification to the user to join a room that is streaming the Friday horror movie. As another example and not by way of limitation, the items and objects may include groups or social networks to which users of virtual-room service system 160 may belong, events or calendar entries in which a user might be interested, computer-based applications that a user may use, transactions that allow users to buy or sell items via the virtual-room service system 160, interactions with advertisements that a user may perform, or other suitable items or objects. A user may interact with anything that is capable of being represented in virtual-room service system 160 or by an external system of third-party system 170, which is separate from virtual-room service system 160 and coupled to virtual-room service system 160 via a network 110.

In particular embodiments, virtual-room service system 160 may be capable of linking a variety of systems and/or entities (e.g., applications, computing systems, mobile devices, etc.). As an example and not by way of limitation, virtual-room service system 160 may enable users to interact with each other as well as receive content from third-party systems 170 or other entities, or to allow users to interact with these systems and/or entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating virtual-room service system 160. In particular embodiments, however, virtual-room service system 160 and third-party systems 170 may operate in conjunction with each other to provide social-networking services to users of virtual-room service system 160 or third-party systems 170. In this sense, virtual-room service system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, virtual-room service system 160 also includes user-generated content objects, which may enhance a user's interactions with virtual-room service system 160. User-generated content may include anything a user can add, upload, send, or “post” to virtual-room service system 160. As an example and not by way of limitation, a user communicates posts to virtual-room service system 160 from a client system 130. Posts may include data such as status updates or other textual data, location information, photos, videos, links, music or other similar data or media. Content may also be added to virtual-room service system 160 by a third-party through a “communication channel,” such as a newsfeed or stream. In particular embodiments, the virtual-room service system 160 may be aware of the context of the content and may be able to further inform the user that the particular content may be explicit. In further embodiments, the virtual-room service system 160 may tag the content in a specific way to assist in identifying explicit material. Content tagging may be employed for users under the age of 18 and users may further be prompted and/or notified prior to entering a room with tagged content.

In particular embodiments, virtual-room service system 160 may include a variety of servers, subsystems, programs, modules, logs, and data stores. In particular embodiments, virtual-room service system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Virtual-room service system 160 may also include suitable components such as network interfaces, security mechanisms, load balancers, failover servers, management-and-network-operations consoles, other suitable components, or any suitable combination thereof. In particular embodiments, virtual-room service system 160 may include one or more user-profile stores for storing user profiles. A user profile may include, for example, and not by way of limitation, biographic information, demographic information, behavioral information, social information, or other types of descriptive information, such as work experience, educational history, hobbies or preferences, interests, affinities, or locations. In particular, interest information may include interests related to one or more categories.

A web server may be used for linking virtual-room service system 160 to one or more client systems 130 or one or more third-party system 170 via network 110. An API-request server may allow a third-party system 170 to access information from virtual-room service system 160 by calling one or more APIs. An action logger may be used to receive communications from a web server about a user's actions on or off virtual-room service system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of virtual-room service system 160. A privacy setting of a user determines how particular information associated with a user can be shared. The authorization server may allow users to opt-in to or opt-out of having their actions logged by virtual-room service system 160 or shared with other systems (e.g., third-party system 170), such as, for example, by designating their preference as a privacy setting. Third-party-content-object stores may be used to store content objects received from third parties, such as a third-party system 170. Location stores may be used for storing location information received from client systems 130 associated with users. Advertisement-pricing modules may combine social information, the current time, location information, or any other suitable information to provide relevant advertisements, in the form of notifications, to a user.

In particular embodiments, a first computing system may access a second computing system using a remote desktop service. In particular, the second computing system may establish a connection with the first computing system by initiating a remote desktop client. The second computing system may further generate and transmit a request to the first computing system for a remote desktop protocol session with the first computing system. In various embodiments, the remote desktop protocol session may be generated using an operating environment in which the settings of the operating environment is defined based on an operating environment configuration file. In particular embodiments, the second computing system may communicate the request to the first computing system through a cloud service. In further embodiments, the first computing system may transmit an authorization to the second computing system that enables the second computing system to begin a remote desktop protocol session between the remote desktop of the second computing system and a remote desktop server application on the first computing system. In various embodiments, the authorization and/or the remote desktop protocol session may also be established through the cloud service. In particular, the second computing system may generate a communication channel with the first computing system. In addition, the first computing system may begin remote desktop protocol data flow over the communication channel to the second computing system. In various embodiments, the remote desktop server application enables the first computing system to control an operating system of the second computing system as well as any component systems of the second computing system, such as, for example, and not by way of limitation, a display of the second computing system. Accordingly, using the remote desktop server application on the first computing system to control the operating system of the second computing system may provide a similar user experience as the user experience of implementing the first computing system to control the operating system of the first computing system.

For example, the second computing system may generate a request for a remote desktop protocol session with the first computing system using a particular operating environment. The operating environment may include components from various networks and systems that may be accessed using network 110. In further embodiments, various components, parts, or nodes of the operating system of the second computing system may access different components, parts, or nodes of the operating environment of the first computing system using the network 110.

In particular embodiments, the second computing system may communicate the request for a remote desktop protocol session through a cloud service to a computing system 130. The cloud service may represent a service or application that controls data through a widely dispersed network, such as network 110, the internet, and so forth. The client system 130 may generate and transmit a response to the request using a cloud service, the internet, network 110, and so forth. In particular embodiments, a display may be generated on the client system 130. The client system 130 may receive user input via the display that enables the second computing system to remotely control the client system 130. In further embodiments, the client system 130 may have a list of second computing systems that are given permission to remotely access and/or control client system 130.

In particular embodiments, the client system 130 may perform an authorization step, in which the client system 130 may first receive a desktop protocol session request from a remote desktop server application through the cloud service. Based on the request, the client system 130 may determine whether to establish a connection with the second computing system. In further embodiments, the first computing system 130 may be a node in the network cloud and may receive the request of a remote connection at the corresponding node of the network cloud.

In further embodiments, responsive to the client system 130 granting permission to the second computing system to establish a remote connection, the client system 130 may establish a communication channel with the second computing system through the cloud server. In particular embodiments, the channel may be created using a secure connection (e.g., using cryptographic protocols such as secure sockets layer (SSL)), or means for ensuring the integrity and security of the data transmitted over the communication channel.

In particular embodiments, data from the remote desktop of the first client system 130 may be transmitted to the second computing system via the communication channel. As a result, various elements of the client system 130 may be displayed on the second computing system. For example, and not by way of limitation, a user interface generated on the client system 130 may be transmitted to and displayed on the second computing system. Accordingly, the display generated on the second computing system may match a display produced on the client system 130. Furthermore, the client system 130 may further use the transmitted display to control one or more operations of the second computing system. In particular, any operation that can be performed on the client system 130 may also be performed on the second computing system using the transmitted display. In particular embodiments, the transmitted display may include one or more graphical elements that are positioned on the display in a manner the matches the layout of the display on the client system 130.

In particular embodiments, in order to remotely access the second computing system, the client system 130 may register the client system 130 and provide one or more system parameters to a remote access gateway. The remote access gateway may further identify the client system 130 and enable the transmission of control signals from the client system 130 to the second computing system to enable control of the second computing system. In various embodiments, registration of the client system 130 may involve one or more hardware and/or software applications and utilize one or more techniques, such as sharing public and private access keys.

In particular embodiments, a client system 130 may remotely access a second computing system 130 using one or more systems such as, for example and not by way of limitation, graphical user interfaces, touch screens, mice, keyboards, and so forth. For example, a user may access a remote desktop using a cellphone, personal digital assistant (PDA), television, touch screen device, or any other suitable device. A remote system may also lack one or more systems, such as, for example and not by way of limitation, a standard mouse and keyboard configuration. In particular embodiments, a user of the client system 130 may control the second computing systems by using various systems, such as a touch screen and/or any other means of controlling the client system 130. However, a user may not be limited by means for controlling the client system 130. For example, and not by way of limitation, a user may implement a control not available on the client system 130 for controlling the second computing system.

In particular embodiments, a display system of the client system 130 may include a user interface (UI) displayed on a screen of the client system 130 and further connected to a processor of the client system 130. The screen may be configured to display various types of content, including for example, and not by way of limitation, text, images (e.g., digital images), audio, video, and so forth. The screen may be configured to be user interactive (e.g., recognize and accept user inputs to interact with device software). The screen may include any suitable type of display, for example, an electrophoretic display, a liquid crystal display (LCD), a light-emitting diode (LED) display, an organic light-emitting diode (OLED) display, an organic field-effect transistor (OFET) display, or other suitable display. This disclosure contemplates any suitable type of display configured to be user interactive. In particular embodiments, a screen may include a touch screen and be capable of receiving gestures from users. A processor associated with the screen may further convert the detected gesture into a control signal for operating the client system 130 and/or for transmission to the second computing system for controlling the second computing system. In particular embodiments, the gesture may include, for example and not by way of limitation, single-touch interactions, multi-touch interactions, proximity-based gestures, and so forth.

In particular embodiments a remote desktop protocol, or any other suitable method known in the art, may be used for video conferencing between a plurality of participants. In particular embodiments the video conferencing may include sending conversation group information from a managing server (or remote desktop) to a second computing system. In particular embodiments, a managing server (or remote desktop, server, etc.) may send multiple participant data streams (e.g., audio and/or video streams) to a set of client systems 130. In particular embodiments, transmitting streams may allow users within a group to each receive a content stream corresponding to various types of data including, for example, and not by way of limitation, audio clips, web content, and/or individually control a remote desktop. In particular embodiments, one or more client systems 130 may control and/or share control of the remote desktop with one or more other client systems 130. In particular embodiments, the client system 130 that controls the remote desktop may choose or select content for streaming to each client system 130 associated with the room. In particular embodiments, one or more client systems 130 may implement the remote desktop protocol for facilitating video conferencing, video chatting, and/or any other suitable form of communication (e.g., audio-video communication) between a plurality of client systems 130. In particular embodiments, each of the one or more client systems 130 that controls the remote desktop may implement a touch screen for receiving user input. For example, a user may provide input to the client system 130, for example, via an electronic hardware device, such as a cellphone with a touch screen. The client system 130 may convert the user input into one or more control signals for controlling the remote desktop. Although the client system 130 may include a touch screen, the remote desktop may not include touch screen functionality. Accordingly, the client system 130 may convert touch screen input into non-touch screen input. Additionally, or alternatively, the client system 130 may receive user input corresponding to non-touch screen controls for controlling a remote desktop that lacks touch screen functionality.

In particular embodiments, each group of client systems 130 may be assigned to a particular remote desktop, server, etc. for their current session. In further embodiments, the group of client systems 130 may be assigned to different remote desktop systems. In further embodiments, there may be hundreds, thousands, millions, or billions of chat room or groups that a client system 130 may join. In further embodiments, each “room” may support data sharing and/or steaming, including audio and/or video sharing between an unlimited number of participant client systems 130.

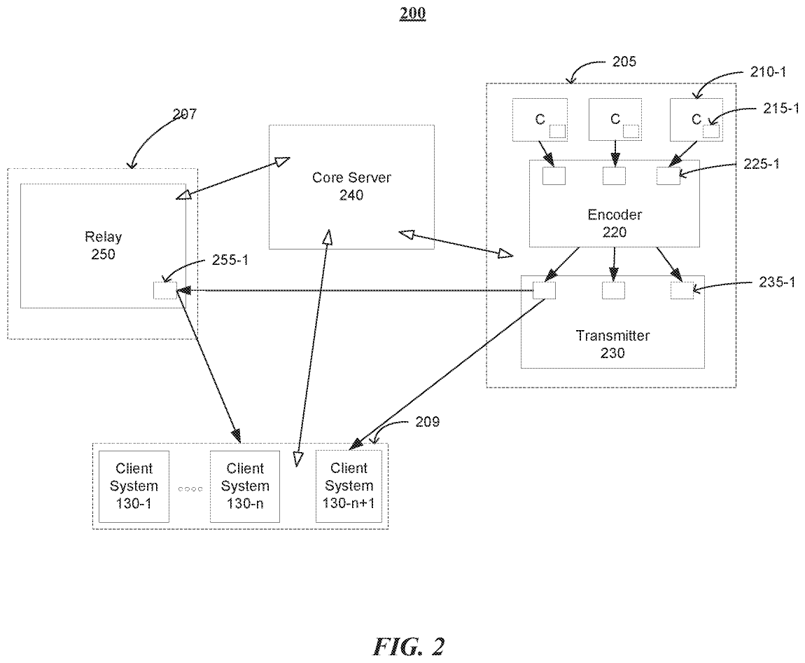

FIG. 2 illustrates an example system 200 for capturing, encoding, and transmitting synchronous information to a plurality of destinations (e.g., a plurality of client systems 130). In particular embodiments, a computing system may enable synchronous playback of content from a source of information to multiple destinations. In particular embodiments, the capture system 210 may capture one or more packets of data (e.g., audio, text, video, and/or image content) from the source of information, encode the packets, and further transmit the encoded packets to various destinations.

In various embodiments, the system 200 may include one or more subsystems, such as, for example, and not by way of limitation, a streaming system 205, a transfer system 207, and a destination system 209. In various embodiments, streaming system 205 may include, for example, and not by way of limitation, one or more capture systems 210, one or more encoder systems 220, and one or more transmitter systems 230. In operation, the system 200 may support one or more processes. In various embodiments, a process may include capturing content via the capture system 210. The process may further include encoding the content via the encoder system 220. The process may also include transmitting the content to client systems 130 via the transmitter system 230.

Structurally, the streaming system 205 may include one or more virtual machines. In particular, each capture system 210 may include one or more virtual machines that processes captured data. In addition, each virtual machine of the capture system 210 may be associated with one or more component computing systems 225 of the encoder system 220. In particular, the component computing systems 225 may encode, convert, and/or otherwise process captured data before transmission to an external capture transfer system (e.g., a transmitter computing system 235 of transmitter 230). In various embodiments, the streaming system 205 may support multiple captures concurrently. In particular, each capture may be routed through individual virtual machines of the streaming system 205. For example, and not by way of limitation, the streaming system 205 may support 10-200 captures in parallel.

In various embodiments, a process may be a streaming event from an external source to a client system 130 via one or more elements of the streamer system 205. For example, the streamer system 205 may support the distribution of one or more processes to client systems 130. In particular, a capture system 210 may capture a process and perform one or more processing steps on the captured content. In particular, the captured content may adjust a bit rate of the captured content and/or may adjust a compression ratio of the received captured content. The capture system 210 may further transmit the capture to the encoder system 220. The encoder system 220 may encode the capture by associating a unique identification key with the capture, by reducing a bit rate and/or a compression ratio of the capture, and so forth. The encoder system 220 may further transmit the capture to the transmitter system 230 for output to the destination system 209. For example, and not by way of limitation, the streamer system 205 may output the captures to the destination system 209 via one or more elements of the transfer system 207.

In various embodiments, the destination system 209 may include one or more client systems 130 that receives captures from the streaming system 205. In particular, each client system 130 may establish a connection with a relay 250 to receive captures from the streaming system 205. Additionally, or alternatively, each client system 130 may establish a direct connection with the streaming system 205 to receive captures.

In various embodiments, a client system 130 may interact with capture system 210. In particular, the client system 130 may be any system capable of sending information to server 162 and/or receiving information from server 162 of the virtual-room server system 160 that is associated with capture system 210. In various embodiments, the capture system 210 may be included in the virtual-room service system 160 and may be further controlled by server 162.

In particular embodiments, capture system 210 may be viewed, controlled, or interacted with by multiple client systems 130. In particular embodiments, the viewing, controlling, or interaction may be synchronous or asynchronous with other client systems 130. In particular embodiments, the operating system of capture system 210 may be configured for control by the client system 130. For example, after the client system 130 accesses the capture system 210, the operating system of capture system 210 may grant client system 130 specific rights and privileges. For example, capture system 210 may grant client system 130 the ability to access certain applications or software to use the capture system 210 (e.g., access to www.youtube.com to view and play videos). In further embodiments, the operating system of capture system 210 may include logic that limits certain rights and privileges of client system 130. For example, and not by way of limitation, capture system 210 may deny client system 130 from accessing or running non-whitelisted software or applications on capture system 210. In particular embodiments, after client system 130 attempts to access or run non-whitelisted software or applications, capture system 210 may terminate a connection with client system 130.

As described above, the capture system 210 may receive content from an external content source (e.g., a third-party system 170, a client system 130, etc.). The capture system 210 may optimize the content by adjusting a bit rate, a resolution, a size, etc. of the content. The capture system 210 may further transmit the optimized content to the encoder system 220. In particular embodiments, capture system 210 may act as a relay between client system 130 and one or more of encoding system 220 and transmitting system 250. In particular embodiments, capture system 210 may capture content (e.g., audio, video, text, image, etc.) of an operating system in real-time. In further embodiments, capture system 210 may optimize the captured content and further send the captured content to encoding system 220. In particular, optimizing the capture content may include for example, and not by way of limitation, adjusting a bit rate, adjusting a resolution, adjusting a packet size, etc. of the input capture. For example, the capture system 210 may implement a first encoding of the captured content before passing the captured content to the encoding system 220. In various embodiments, one or more functions of capture system 210 may be managed by client system 130. In particular, the capture system 210 may enable or disable user input and/or control of capture system 210 functionalities via client system 130. These functionalities include, for example, and not by way of limitation, capturing content, encoding content, transmitting content to the encoder system 220, etc. For example, the capture system 210 may disable user input via the client system 130 that corresponds to malicious operations.

In particular embodiments, capture system 210 may be comprised of hundreds, thousands, or millions of servers (e.g., remote desktops) located across one or more locations (e.g., states, countries, the entire globe, etc.). In particular embodiments, client system 130 may be assigned a control 220 that is associated with a specific server 215 in capture system 210. In particular, the client system 130 may be assigned to a server 215 in capture system 210 based on a geographic location, specific hosts, a regional request, speed, time, bandwidth, or capacity. In particular embodiments, the servers of capture system 210 may be clustered within a zone. Zones may include geographic areas, such as zip codes, neighborhoods, addresses, and so forth. In further embodiments, multiple zones may constitute a region, such as a city, a county, a state, and so forth. In particular embodiments, in the event of a power outage or server failure, streaming system 205 may start a new capture system 210 and re-assign client system 130 to a new server 215 that receives control signals from a client system 130 for further completes an action corresponding to the received control signals. In particular embodiments, one client system 130 may transmit controls signals and/or content to one server 215 of capture system 210. In further embodiments, multiple client systems 130 may transmit control signals and/or content to a single server 215 of capture system 210. In particular embodiments, a server 215 of capture system 210 may receive captured data corresponding to one or more stream during one or more times intervals, during a sequence of time intervals, and so forth. Streams may include, for example and not by way of limitation, video streams, audio streams, image streams, textual streams, and so forth.

In particular embodiments, capture system 210 may implement one or more features to protect the privacy of client systems 130. For example, the capture system 210 may store user data in temporary, volatile, and non-retrievable memory. In further embodiments, upon client system 130 terminating a connection with a particular capture server 215 of capture system 210, capture system 210 may erase all data and memory associated with the concluded session of the client system 130.

In particular embodiments, captured content may be transmitted in either a RAW format or a compressed format with a minimal time delay (e.g., as close to real-time as is possible while protecting the quality of the transmitted data). In particular embodiments, when encoding system 220 receives the captured content, the encoding system 220 execute a confirmation step to determine that the captured audio content and/or video content is in a correct format for decompressing. For example, one input feed may be captured and encoded into VP8 (primarily for the Google Chrome™ web browser) and H.264 (Other supporting browsers e.g. Mozilla Firefox™) at any number of resolutions (e.g., low, medium, high, etc.), with various frame rates (e.g., 12, 15, 18, 24, 30, 60, etc.). Accordingly, the encoding system 220 may convert the received content into one or more formats before performing one or more encoding operations. During encoding, the encoding system 220 may perform one or more encoding operations, including, for example, and not by way of limitation, adjusting a resolution of the content based on a capacity of the client system 130. In particular embodiments, transmitting large files over a transmission channel may reduce available bandwidth of the transmission channel, thereby degrading a user experience. Accordingly, modifying the content resolution based on parameters of the client system 130 may reduce transmission channel usage and improve streaming performance.

In particular embodiments, the client system 130 may request control of a server associated with capture system 210 from streaming system 205. In particular, in response to receiving a request for control, streaming system 205 may deliver a key (e.g., a private access key) to client system 130. The client system 130 may further use the key when establishing a connection with the capture system 210 and/or the streaming system 205. In particular embodiments, if a connection is established between the client system 130 and the streaming system 205 and/or the capture system 210 that does not utilize a corresponding key, that does not provide a valid handshake between the key of the client system 130 and a key associated with the streaming system 205 and/or provides invalid data during a connection, the streaming system 205 may revoke access to the client system 130 and/or sever 215 and further terminate a connection with the client system 130.

In particular embodiments, capture system 210 may capture content corresponding to an operating system for display on a client system 130. In particular, the capture system 210 may automatically adjust the size and layout of an operation system based on control signals received from the client system 130. For example, the capture system 210 may adjust the size and layout to match a keyboard layout. In further embodiments, capture system 210 may automatically format the operating system based on one or more system parameters of the client systems 130, including, for example, and not by way of limitation, a country of origin, one or more language preferences, and so forth. In further embodiments, capture system 210 may configure the operating system for client system 130 based at least in part on a profile associated with a user of client system 130. In particular embodiments, capturing system 210 may scale the display of client system 130 based on one or more preferences specified in the user profile. In further embodiments, capturing system 210 may interpret mouse and keyboard input from client system 130 (e.g., for using in selecting content for streaming to client system 130). In particular, the mouse and keyboard inputs may be interpreted, translated, and sent in the smallest possible format to a corresponding server of capture system 210. In further embodiments, the corresponding server 215 that receives the inputs may modify an operating system associated with the capture system 210.

In particular embodiments, a client system 130 may establish a direct connection with a capture system 210. In particular, the client system 130 may control one or more functionalities of the capture system 210 utilizing the direct connection, thereby reducing latency. For example, the client system 130 may control the streaming and/or relay of content from the streaming system 205 to the client system 130. In particular embodiments, the capture system 210 may receive user inputs via the direct connection and further execute one or more actions responsive to the user input. Actions may include, for example, and not by way of limitation, moving a mouse icon, selecting keyboard inputs, and so forth. In further embodiments, the client system 130 may modified a stream (e.g., an audio stream) and/or a feed (e.g., a video feed) transmitted to the encoding system 220 and/or transmitter system 230. The modified content (e.g., the audio stream and/or the video feed) may be transmitted back to the client system 130 by the transmitter system 230.

In particular embodiments, a total time from selecting content for processing by the streaming system 205 to receiving updated captures at the client system 130 may be determined by the following formula:
(latency and accuracy of sending user input from client system 130 to a server of capture system 210)
+(time associated with interpretation of received user input and signaling the operating system of the capture system 210)
+(time associated with generating and transmitting new capture to encoder system 220)
+(time associated with encoding a received capture)
+(time associated with delivering encoded capture to transmitter system 230)
+(time associated with transmitting encoded capture to client system 130)
+(latency and accuracy associated with delivering encoded capture to client system 130)
+(time associated with buffering and rendering encoded capture on client system 130)
=Total Time,
   where the total time may be defined as a duration between the client system 130 receiving user input corresponding to a modification of the capture system 210 and the client system 130 rendering a modified capture corresponding to the user input. In various embodiments, the streaming system 205 may minimize the total time, thereby reducing latency between the client system 130 receiving user input and rending an updated capture on the client system 130. In various embodiments, the total time may be reduced to nearly 0 milliseconds. In at least one embodiment, fewer than all of the above may be used to determine the total time from selecting content for processing.

In particular embodiments, encoder system 220 may receive captured content from capture system 210, encode the captures, and further transmit the encoded captures to the transmitter system 230. The encoder system 220 may convert the received content into one or more data formats. The encoder system 220 may select the data format(s) based on a system parameter of the destination system 209. For example, and not by way of limitation, if a destination client system 130 can read data of a particular file type, the encoder system 220 may encode data into a file format that corresponds to the file format. For example, and not by way of limitation, the encoder system 220 may convert video content into one or more of a Waveform Audio File Format file, a Moving Picture Experts Group 4 video file, an Audio-Video Interleave file, and so forth.

In addition, the encoder system 220 may receive content at high bit rates, high resolution, large packet sizes, high compression ratios, etc. to enable efficient transfer of large data packets from the capture system 210 to the encoder system 220. The encoder system 220 may process and/or convert the received content into lower bitrate, lower resolution, and/or lower packet size captures. For example, the encoder system 220 may convert a high bitrate content into real-time, lower resolution content for transmittal to one or more client systems 130 via transmit system 250. In various embodiments, the encoding system 220 may be located proximate to capture system 210 in the streaming system 205. Placing encoding system 220 proximate to capture system 210 may reduce latency due to transmitting large data packets corresponding to captures over long distances. In further embodiments, encoder system 220 may also encode received captures into one or more data formats. The encoder system 220 may select a data format based on an output format that may be readable by a receiving client system 130.

In various embodiments, the encoder system 220 may output encoded captures in multiple levels of quality. For example, and not by way of limitation, output qualities may range from ultra-low quality and low resolution to ultra-high definition encoded captures. The encoder system 220 may select the output level of quality based on the available bandwidth of the streaming system 205 and the system parameters of the client system 130. For example, and not by way of limitation, if only a few client systems 130 are using streaming system 205 at a given interval in time, then the encoding system 220 may encode the received data to transmit ultra-high definition to each of the client system 130. However, if the transmission capacity of the streaming system 205 is limited (e.g., a larger number of client systems 130 are receiving captures form the streaming system 205), then the encoder system 220 may reduce and/or limit the level of quality of encoded captures in order to reduce the bandwidth demand on the streaming system 205.

In various embodiments, the streaming system 205 may route content to the destination system 209 via the transfer system 207. For example, and not by way of limitation, the transfer system 207 may include one or more relays 250. In various embodiments, relays 250 of the transfer system 207 (e.g., relay 250) may include one or more of server farms, constellations of computing systems, and so forth. The relay 250 may also include an operational management server and one or more computing systems 255.

For example, relay 250 may receive, from transmitter 230, captures via an I/O system associated with the relay 250. The I/O system may transmit the capture to an operational management server of the relay 250. The operational management server may identify an available computing system 255 for processing the capture and further transmit the capture to the available computing system 255. In various embodiments, after the computing system 255 receives the capture, the computing system 255 may process the capture. For example, and not by way of limitation, the computing system 255 may determine a routing for the capture and/or determine a destination client system 130 for the capture. The computing system 255 may further transmit the capture and the routing to the I/O system of relay 250 for output to the destination client system 130. The I/O system may further transmit the capture to the destination client system 130 via the routing. For example, based on the routing generated by the computing system 255, the relay 250 may output the capture to another relay 250 and/or may output the capture to a client system 130-n+1.

In operation, the operation management server of relay 250 may identify one or more computing systems 255 that are available to process the capture. For example, the operation management server may determine that one or more computing systems 255 have completed receiving a capture from transmitter 230 and are available to accept a subsequent capture. Additionally, or alternatively, the operation management server may identify a computing system 255 that is in an “off” or “inactive” state. The operation management server may turn on the identified computing system 255 and perform one or more checks to determine that the computing system 255 is functional and capable of processing captures. The operation management server may determine based on the checks that the computing system 255 is functional and further route a capture to that computing system. In various embodiment, the computing system 255 may receive the capture from the operation management server and further perform one or more processing steps. For example, and not by way of limitation, the computing system 255 may determine a destination for the capture (e.g., a client system 130). Additionally, or alternatively, the computing system 255 may read a public access key of the encoded capture and further identify a client system 130 associated with the private access key. The computing system 255 may identify the determined client system as the destination for the capture.

In various embodiment, the transfer system 207 may output the processed capture to a client system 130. For example, and not by way of limitation, the transfer system 207 may provide a HTTPS URL to the client system 130 for accessing the encoded capture. Additionally, or alternatively, an I/O system associated with relay 250 may output captures to each client systems 130 identified by the computing systems 255 of the relay 250. For example, and not by way of limitation, a computing system 255 may designate a destination client system 130 by appending a client system 130 identifier to the encoded capture. In various embodiments, the client system 130 may receive an encoded capture. The client system 130 may further decode the capture and output the captured content to the user. For example, and not by way of limitation, the client system may establish a secure connection with the relay 250 (e.g., via network 110 using a HTTPS URL). The client system 130 may further download content from the transfer system 207. Additionally, or alternatively, the client system may add the capture to a buffer for storing content for delivery to a user (e.g., audio, visual, video, etc.).

In various embodiments, a fixed number of encryptions may be utilized by the system 200. For example, the system 200 may implement one encryption per process. Additionally, or alternatively, the system 200 may utilize more (e.g., 100 encryptions with 60 processes) or fewer (e.g., 50 encryptions with 90 processes). In various embodiment, the system 200 may transmit a unique encryption private access key to each client system 130 connected with a transfer system 207 up to the fixed limit (e.g., each client system 130 connected to a relay 250). The client system 130 may utilize the received private access key to decrypt captures from the transfer system 207. In particular, the transfer system 207 may transmit encrypted captures with a public access key that matches the private access key of the respective client system 130. Accordingly, the client system 130 may receive encrypted captures that the client system 130 is capable of decrypting.

In other embodiments, the system 200 may prove private access keys to a subset of the client systems 130 that receive captures. Accordingly, each client system 130 that receives a private access key may receive encrypted captures. However, client systems 130 that do not receive private access keys may receive unencrypted captures. In such embodiments, the system 200 may transmit unencrypted captures to the transfer system 130 over a secured channel to protect the unencrypted data. Similarly, the transfer system 130 may transmit the unencrypted captures to the client systems 130 using a secured channel to protect the unencrypted data.

In various embodiments, the transmitter 230 may support one or more processes in parallel. For example, and not by way of limitation, the transmitter 230 may support 10-100 or more processes in parallel. In addition, the transmitter 230 may transmit a processed capture to multiple users (e.g., 10 or more users). Accordingly, the transmitter 230 may relay captured data from the system 200 to multiple client systems 130.

In various embodiments, a transmitter 230 may support a limited number of client systems 130. For example, and not by way of limitation, a transmitter computing system 235 may process up to N captures in parallel. The transmitter computing system 235 may further transmit each capture to n client system 130. Accordingly, the transmitter computing system 235 may support up to M=N×n client systems. Accordingly, if N+1 client systems 130 attempt to connect to the transmitter computing system 235, the transmitter computing system 235 may be unable to deliver captures to at least one of the N+1 client systems (e.g., client system 130-n+1). Accordingly, ways to provide access to captures for client systems that exceed the client system limit of a transmitter 230 may be useful. In addition, ways to provide access to captures for client systems that do not use data associated with connections to transmitter 230 may also be useful, as such data may be expensive.

In various embodiments, the system 200 provides a solution to this problem. In particular, the system 200 includes one or more relays that receive encoded captures from the transmitter 230. In various embodiments, a relay may receive an encoded capture that is not encrypted. In such embodiments, the encoded captures may be transmitted over a secure communication channel to protect the unencrypted encoded captures.

In the embodiment of system 200, core server 240 handles setup and messaging between other components in the system. For example, when the core server 240 receives a connect request from a client system 130, an operational management server of the core server 240 determines whether: (a) an active computing system is available for processing the capture request, and/or (b) an inactive computing system can be activated for processing the capture request. FIG. 2 illustrates the flow of such communications using open arrows, while the flow of capture streams is shown with closed arrows. Not every communication is shown in FIG. 2; for example, client system 130 may communicate directly with streamer system 205 and with relay 250, and streamer system 205 and relay 250 may exchange communications other than streams between them (e.g., to coordinate the delivery of a stream from transmitter 230 to a relay 250).

The core server 240 may receive the connect request from a client system 130, the core server 240 may determine one or more processes to transmit to the client system. For example, and not by way of limitation, the core server 240 may receive a connect request from the client system. In various embodiments, the client system 130 may generate a request to provide one or more streams of capture data. Additionally, or alternatively, the core server 240 may transmit a request to system 205 that a new capture be transmitted to a client system.

In various embodiments, the connect request received from the client system 130 may exceed a number of client systems 130 supported by transmitter 230. Accordingly, the core server 240 may generate a request to a relay 250 to transmit a capture to a requesting client system.

For example, and not by way of limitation, an I/O system of the relay may receive the request and further transmit the request to an operation management server of the relay 250. Based on the request, the operation management server may determine a number of computing systems 255 of the relay 250 that are capable of processing captures. The operation management server may further determine a number of client systems 130 that the relay 250 can support. The operation management server may further generate a notification to the core server 240 that indicates a number of processes and a number of client systems 130 per process that is supported. An I/O system of the relay 250 may output the notification to the core server 240. In addition, the operation management server may further transmit an HTTPS URL address to the relay 250 to facilitate the client systems 130-n+1 in connecting to the relay 250.

Based on the received notification, the core server 240 may determine that a capture should be output to the relay 250 for transmission to a client system 130. For example, and not by way of limitation, the core server 240 may identify one or more client systems 130 to connect to the relay (e.g., client system 130-n+1, client system 130-n+2, etc.). The core server 240 may further identify a supported process for transmission to the client system 130 and/or the system 200 may generate a new process by configure a new virtual machine to capture content (e.g., video and/or audio content) associated with the process requested by the client system 130. In addition, the core server 240 may transmit the HTTPS URL to the client system(s) to enable connection to the relay 250.

As described above, the relay 250 may process the capture by identifying an available computing system 255 (and/or turning on an inactive computing system 255) and transmitting the received capture to the client system(s) 130. In various embodiments, relays 250 may be added as networks, instead of being added in series in order to reduce latency and reduce a number of client systems 130 affected by a relay failure.

In further embodiments, the transmitter system 230 of the system 200 may transmit captures to multiple destinations (e.g., to multiple relays 250). The transmitter system 230 may send encrypted versions of captures to client systems 130 and send unencrypted versions of captures to each relay 250. In various embodiments, each of the communication channels over which the system 200 transmits content to the relay 250 is secure. Similarly, the core server 240 and the relay 250 messages over secure channels. Transmitter system 230 transmits captures to multiple destinations (e.g., client systems 130, a relay 250, etc.).

In various embodiments, relays 250 may be located relatively near one or more client systems 130 to reduce data transfer latency. In addition, as client systems 130 are added to the system 200, a connection of the new client systems 130 may be routed to a geospatially nearest relay in order to reduce latency.

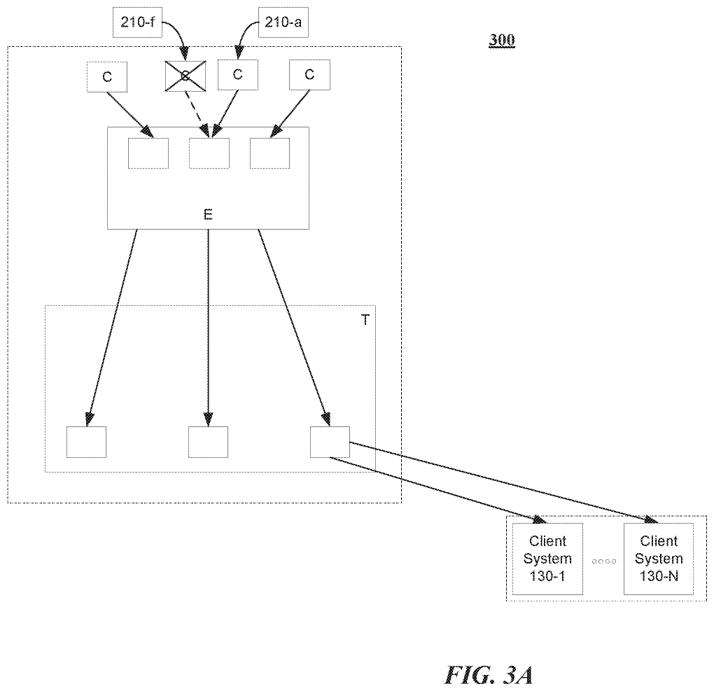

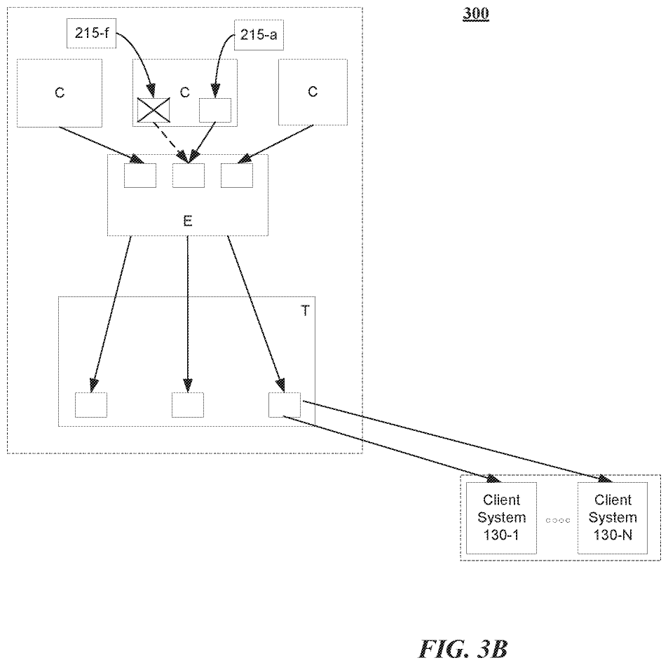

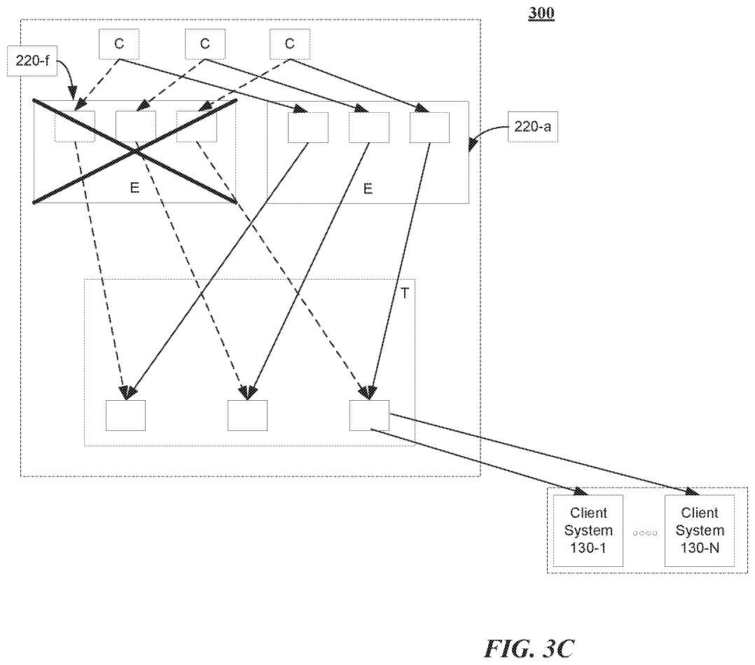

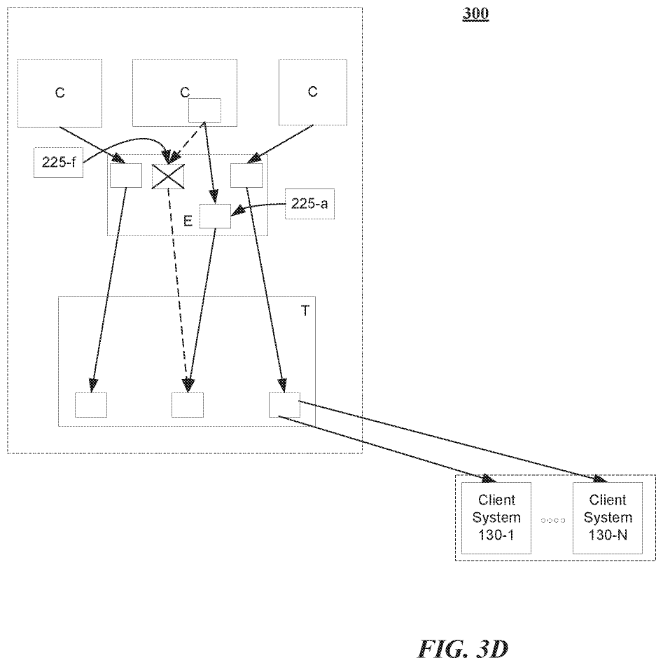

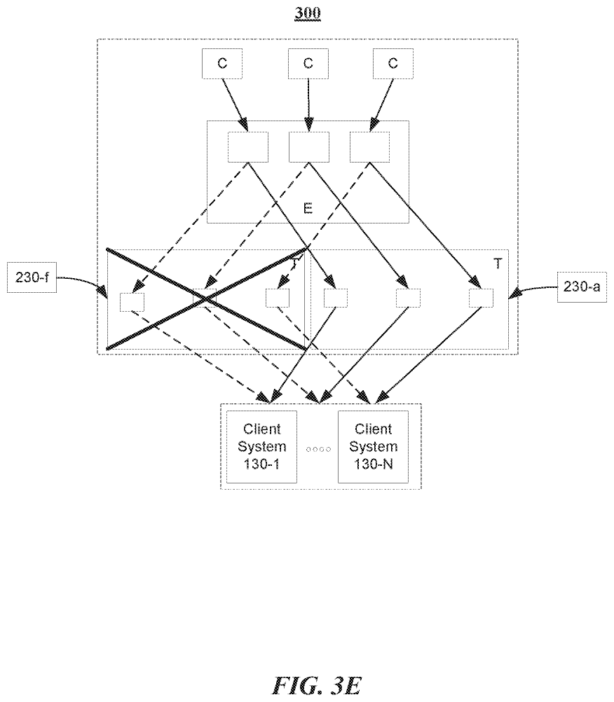

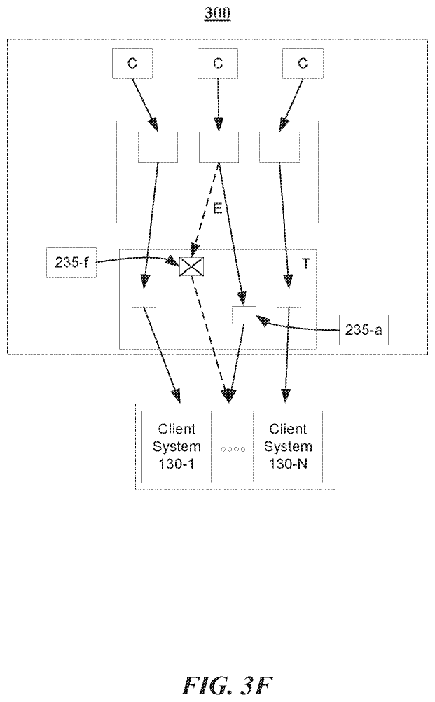

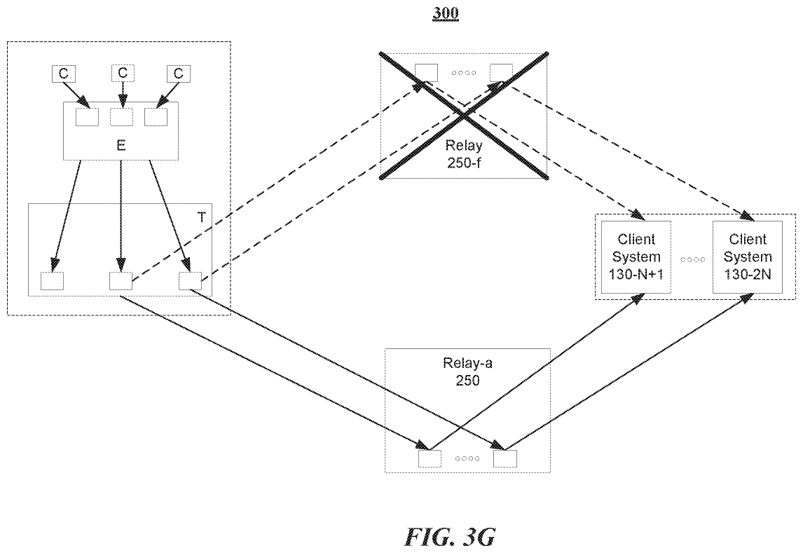

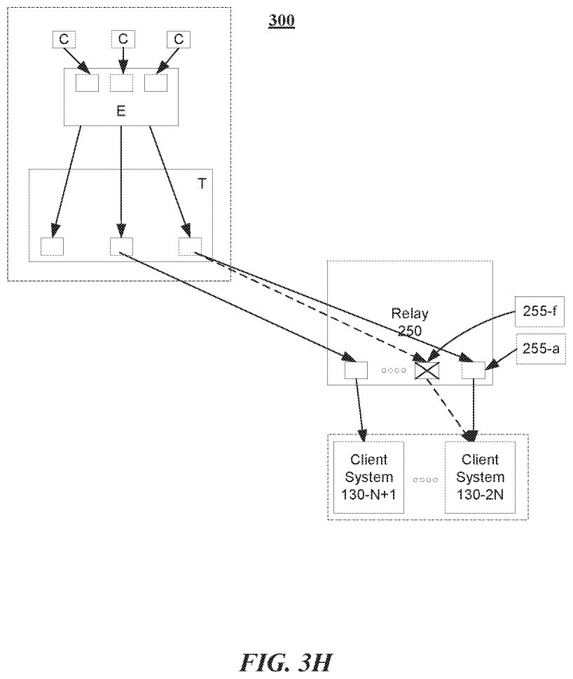

FIGS. 3A-3H illustrates an example system 300 with system failure and crash resolution, according to various embodiments. In particular, one or more elements of the system 200 may malfunction. Malfunctions may include, for example and not by way of limitation, power failure, processing errors, input and/or output routing errors, and so forth. Any elements of the system 200 may malfunction including, for example, and not by way of limitation, a streamer system 205, a core server 240, a relay 250, and so forth. In addition or as an alternative, any component of the streamer system may malfunction, including a capture system 210, an encoder system 220, a transmitter computing system 235, a component computing system 255, and so forth.

In various embodiments, malfunctions may interrupt the flow of encoded captures to one or more client systems 130. In particular, malfunctions may cause encoded captures to be routed to an incorrect destination client system 130, to be improperly processed by a component computing system 255, the routed encoded capture to not reach a destination client system 130, the operational management server of a relay 250 to malfunction, and so forth. Accordingly, malfunctions may cause interruptions in the transmission of encoded captures in the system 300 and/or en route to a destination client system 130.

In order to restore interrupted capture transmission, encoded captures may be re-routed to alternative elements and/or components of the system 200. For example, an encoded capture routed to a first component computing system 255 may be routed to a second component computing system 255 when the first component computing system 255 malfunctions. Additionally, or alternatively, an element of the system 200 may malfunction. Accordingly, encoded captures may be routed away from the malfunctioning element.

FIG. 3A illustrates a crash recovery process for capture system 210 malfunctions, according to various embodiments. In particular, if a capture system 210-f malfunctions, then the streamer system 205 may identify an alternative capture system 210-a to assume the processing steps of the malfunctioning capture system 210-f. For example, the streamer system 205 may identify an alternative capture system 210-a that is in an off state or an idle state. An alternative capture system 210-a may be in an off state during extended intervals between capturing audio content and/or video content from an external source (e.g., an external server), while the alternative capture system 210-a may be in an idle state during temporary time intervals between capturing audio content and/or video content. If the alternative capture system 210-a is in an off state or an idle state, the streamer system 205 may transmit a notification to the streamer system 205 that configures the alternative capture system 210-a to transition to an on state. In the on state, the alternative capture system 210-a may receive audio content and/or video content from the external source and process the audio content and/or video content to produce high bitrate data for transmission to an encoder system. The streamer system 205 may further configure the alternative capture system 210-a to receive and process the audio content and/or video content from the external source to generate high bitrate data for transmission to one or more encoder systems.

FIG. 3B illustrates a crash recovery process for a malfunction of a component computing system 215-a of the capture system 210, according to various embodiments. In various embodiments, if a component computing system 215-f malfunctions, then the operation management server of the corresponding capture system 210 may identify an alternative component computing system 215-a to assume the processing steps of the malfunctioning component computing system 215-a-f. For example, the operation management server may identify a component computing system 215-a that is in an off state or an idle state. A component computing system 215-a may be in an off state during extended intervals between processing high bitrate data from the capture system, while the component computing system 215-a may be in an idle state during temporary time intervals between processing high bitrate data. If the component computing system 215-a is in an off state or an idle state, the operation management server may transmit a notification to the component computing system 215-a that configures the component computing system 215-a to transition to an on state. In the on state, component computing system 215-a may receive high bitrate data from an external data source (e.g., third-party system 170, a client system 130, etc.) and further generate one or more captures (e.g., data packets) for transmission to an encoder system 220. In particular, the operation management server may route input data for the malfunctioning component computing system 215-a to the available component computing system 215-a. The component computing system 215-a may further process the input data to produce one or more captures and deliver the captures to an I/O system for output to the encoder system 220.

FIG. 3C illustrates a crash recovery process for encoder system 220 malfunctions, according to various embodiments. In particular, if an encoder system 220-f malfunctions, then the streamer system 205 may identify an alternative encoder system 220-a to assume the processing steps of the malfunctioning encoder system 220-f In operation, the encoder system 220 receives high bitrate data from one or more capture systems 210. The encoder system 220 further processes the high bitrate data using one or more component computing systems 225 to produce data captures for transmission to client systems 130. In particular, encoded captures may have various format types, resolutions, bitrates, and so forth. In various embodiments, encoder system 220-f malfunctions may result in the encoder system 220-f converting high bitrate input from the capture system 210 into an inappropriate output format type, resolution, bitrate, and so forth. In particular, the encoded capture outputted by the encoder system 220-f may be unusable by an end user (e.g., a client system 130).

In various embodiments, if an encoder system 220-f malfunctions, then the streamer system 205 may identify an alternative encoder system 220-a to assume the processing steps of the malfunctioning encoder system 220-f. For example, the streamer system 205 may identify an encoder system 220-a that is in an off state or an idle state. An encoder system 220-a may be in an off state during extended intervals between receiving high bitrate data from a capture system 210 and/or transmitting encoded captures to a transmitter system 230, while the encoder system 220-a may be in an idle state during temporary time intervals between receiving input data and/or transmitting encoded captures. If the encoder system 220-a is in an off state or an idle state, the streamer system 205 may transmit a notification to the encoder system 220-a that configures the encoder system 220-a to transition to an on state. In the on state, the encoder system 220-a may receive high bitrate data from a capture system 210 and further process the data to produce encoded captures for transmission to an end user (e.g., a client system 130). In particular, the encoder system 220-a may transmit the encoded captures to a transmitter system 230.

In various embodiments, the streamer system 205 may transmit a notification to a capture system 210 to transmit high bitrate data to the alternative encoder system 220-a. In particular, the streamer system 205 may determine a time at which the alternative encoder system 220-a may be operational to receive and process high bitrate data and an address of the alternative encoder system 220-a. The streamer system 205 may further transmit the determined time and the address to the capture system. In response the capture system 210 may transmit high bitrate data to the alternative encoder system 220-a at the determined time using the received address.

In various embodiments, the streamer system 205 may also configure the transmitter system 230 to establish a connection with the alternative encoder system 220-a to receive encoded captures. The streamer system 205 may also transmit the determined time and the address of the alternative encoder system 220-a to the transmitter system 230. Accordingly, the transmitter system 230 may establish a connection with the alternative encoder system 220-a at the determine time using the received address.

FIG. 3D illustrates a crash recovery process for a malfunction of a component computing system 225-f of the encoder system 220, according to various embodiments. In particular, the encoder system 220 may include one or more component computing systems 225 that encode high bitrate data received from the capture system 210. In various embodiments, the encoder system 220 may include an operation management server that routes input to capture system 210 input to one or more component computing systems 225 for processing. The component computing systems 225 may process the input data to generate encoded captures that are delivered to an I/O system for output to the transmitter system 230. In various embodiments, one or more component computing systems 225 of the encoder system 220 may malfunction. In particular, a component computing system 225-f may not process or in appropriately process input data, thereby generating output encoded captures that are not usable by an end user (e.g., a client system 130).

In various embodiments, if a component computing system 225-f malfunctions, then the operation management server may identify an alternative component computing system 225-a to assume the processing steps of the malfunctioning component computing system 225-f. For example, the operation management server may identify a component computing system 225-a that is in an off state or an idle state. A component computing system 225-a may be in an off state during extended intervals between processing high bitrate data from the capture system 210, while the component computing system 225-a may be in an idle state during temporary time intervals between processing high bitrate data. If the component computing system 225-a is in an off state or an idle state, the operation management server may transmit a notification to the component computing system 225-a that configures the component computing system 225-a to transition to an on state. In the on state, component computing system 225-a may receive high bitrate data from a capture system 210 and further process the data to produce encoded captures for transmission to an end user (e.g., a client system 130). In particular, the operation management server may route input data for the malfunctioning component computing system 225-f to the alternative component computing system 225-a. The component computing system 225 may further process the input data to produce encoded captures and deliver the encoded captures to the I/O system for output to the transmitter system 230.

FIG. 3E illustrates a crash recovery process for transmitter system 230-f malfunctions, according to various embodiments. In operation, the transmitter system 230 receives encoded captures from one or more encoder systems 220. The transmitter system 230 further outputs the received encoded captures to one or more client systems 130. In various embodiments, transmitter system 230 malfunctions may result in encoded captures not being transmitted to client systems 130.

In various embodiments, if a transmitter system 230-f malfunctions, then the streamer system 205 may identify an alternative transmitter system 230-a to assume the processing steps of the malfunctioning transmitter system 230-f For example, the streamer system 205 may identify a transmitter system 230-a that is in an off state or an idle state. A transmitter system 230-a may be in an off state during extended intervals between receiving encoded captures from an encoder system 220 and/or outputting encoded captures to one or more of client systems 130 or relays 250 while the transmitter system 230-a may be in an idle state during temporary time intervals between receiving encoded captures and transmitting encoded captures. If the transmitter system 230-a is in an off state or an idle state, the streamer system 205 may transmit a notification to the transmitter system 230-a that configures the transmitter system 230-a to transition to an on state. In the on state, the transmitter system 230-a may receive encoded captures from an encoder system 220 and further transmit the encoded captures to client systems and/or relays 250. After the transmitter system 230-a transitions from the off state or idle state to the on state, the streamer system 205 may configure the transmitter system 230-a to receive and transmit encoded captures. In particular, the transmitter system 230-a may transmit a notification to the streamer system 205 that indicates a time at which the transmitter system 230-a may be ready to receive and/or transmit encoded captures and/or an address of the transmitter system 230-a for establishing data connections.

In various embodiments, the streamer system 205 may re-route encoded captures from the malfunctioning transmitter system 230-f to an alternative transmitter system 230-a that is in the on state. For example, the streamer system 205 may transmit a notification to an encoder system 220 that instructs the encoder systems 220 to transmit encoded captures to an alternative transmitter system 230-a. In particular, the streamer system 205 may determine a time at which the alternative transmitter system 230-a may be operational to receive and transmit encoded captures and an address of the alternative transmitter system 230-a. In various embodiments, the streamer system 205 may determine the time and the address based on a notification received from the alternative transmitter system 230-a. The streamer system 205 may further transmit the determined time and the address to the encoder system 220. In response the encoder system 220 may transmit encoded captures to the alternative transmitter system 230-a at the determined time using the received address.

In various embodiments, the streamer system 205 may also configure one or more external systems (e.g., client systems 130 and/or relays 250) to establish a connection with the alternative transmitter system 230-a in order to receive encoded captures. In particular, the streamer system 205 may transmit the determined time and the address of the alternative transmitter system 230-a to the external systems. Accordingly, the external systems may establish a connection with the alternative transmitter system 230-a at the determine time using the received address to resume receiving encoded captures.

FIG. 3F illustrates a crash recovery process for a malfunction of a component computing system 235-f of the transmitter system 230, according to various embodiments. In various embodiments, the transmitter system 230 may include one or more component computing systems 235 that determine a destination and/or a routing for each encoded capture received from the encoder system 220. For example, a destination may include a client system 130 and a routing may include a sequence of one or more relays 250 that connect the transmitter system 230 to a destination client system 130. In further embodiments, the transmitter system 230 may include an operation management server that routes encoded captures to one or more component computing systems 235 of the transmitter system 230 for processing. The component computing systems 235 may process the encoded captures, append a destination and/or a routing to each encoded capture, and further deliver the encoded capture to an I/O system for transmission to an external system. In various embodiments, one or more component computing systems 235-f of the transmitter system 230 may malfunction. In particular, a component computing system 235-f may not process or may inappropriately process encrypted captures, thereby causing the encoded captures to be mis-routed and/or otherwise not delivered to an appropriate client system 130.

In various embodiments, if a component computing system 235-f malfunctions, then the operation management server may identify an alternative component computing system 235-a to assume the processing steps of the malfunctioning component computing system 235-f. For example, the operation management server may identify a component computing system 235-a that is in an off state or an idle state. A component computing system 235-a may be in an off state during extended intervals between processing encoded captures from the encoder system 220, while the component computing system 235-a may be in an idle state during temporary time intervals between processing encoded captures. If the component computing system 235-a is in an off state or an idle state, the operation management server may transmit a notification to the component computing system 235-a that configures the component computing system 235-a to transition to an on state. In the on state, a component computing system 235-a may receive encoded captures from the operation management server and further process the encoded captures (e.g., determining a destination and/or a routing for the encoded capture). In particular, the operation management server may route encoded captures from the malfunctioning component computing system 235-f to the alternative component computing system 235-a. The alternative component computing system 235-a may further process the received encoded capture and deliver the processed capture to an I/O system of the transmitter system 230 for output to an external system.

FIG. 3G illustrates a crash recovery process for relay 250-f malfunctions, according to various embodiments. In operation, the relay 250 receives encoded captures from one or more transmitter system 230 or other relay 250. The relay 250 further outputs the received encoded captures to one or more client systems 130. In various embodiments, the relay 250 may transmit the received captures directly to a client system 130. Additionally, or alternatively, the relay 250 may use one or more relays 250 to transmit encoded captures to client systems 130. In various embodiments, relay 250-f malfunctions may result in encoded captures not being transmitted to client systems 130 and/or encoded captures being transmitted to an inappropriate client system 130, and/or relay 250 (e.g., a client system 130 that is not a designated recipient of an encoded capture, a relay 250 that transmits an encoded capture to a client system 130 that is not a designated recipient of the encoded capture, etc.).

In various embodiments, if a relay 250-f malfunctions, then the core server 240 may identify an alternative relay 250-a to assume the processing steps of the malfunctioning relay 250-a. For example, the core server 240 may identify a relay 250-a that is in an off state or an idle state. In various embodiments, the core server 240 may identify a relay 250-a based on a proximity between the relay 250-a and one or more client systems 130 connected to the malfunctioning relay 250-f In particular, the core server 240 may preferentially select a relay 250-a that is proximate to at least one of the one or more client systems 130 connected to the malfunctioning relay 250-f. Furthermore, a relay 250-a may be in an off state during extended intervals between receiving encoded captures from a transmitter system 230 and/or another relay 250-a and/or outputting encoded captures to client systems 130 and/or other relays 250-a, while the relay 250-a may be in an idle state during temporary time intervals between receiving encoded captures and transmitting encoded captures. If the relay 250-a is in an off state or an idle state, the core server 240 may transmit a notification to the relay 250-a that configures the relay 250-a to transition to an on state. In the on state, the relay 250-a may receive encoded captures from a transmitter system 230 and/or relay 250-a and further transmit the encoded captures to client systems 130 and relays 250-a. After the relay 250-a transitions from the off state or idle state to the on state, the core server 240 may configure the relay 250-a to receive and transmit encoded captures. In particular, the alternative relay 250-a may transmit a notification to the core server 240 that indicates a time at which the alternative relay 250-a may be ready to receive and/or transmit encoded captures and/or an address of the alternative relay 250-a for establishing data connections.

In various embodiments, the core server 240 may re-route encoded captures from the malfunctioning relay 250-f to an alternative relay 250-a. For example, the core server 240 may transmit a notification to a transmitter system 230, core server 240 and/or another relay 250 that instructs the transmitter system 230 and/or other relays 250 to transmit encoded captures to an alternative relay 250-a. In particular, the core server 240 may determine a time at which the alternative relay 250-a may be operational to receive and transmit encoded captures and an address of the alternative relay 250-a (e.g., a HTTPS URL address). In various embodiments, the core server 240 may determine the time and the address based on a notification received from the alternative relay 250-a. The core server 240 may further transmit the determined time and the address to the transmitter system 230 and/or other relay 250. In response the transmitter system 230 and/or other relay 250 may transmit encoded captures to the alternative relay 250-a at the determined time using the received address.

In various embodiments, the core server 240 may also configure one or more external systems (e.g., client systems 130, other relays 250, etc.) to establish a connection with the alternative relay 250-a in order to receive encoded captures. In particular, the core server 240 may transmit the determined time and the address of the alternative relay 250-a to the external systems. Accordingly, the external systems may establish a connection with the alternative relay 250-a at the determine time using the received address to resume receiving encoded captures.

FIG. 3H illustrates a crash recovery process for a malfunction of a component computing system 255-f of the relay 250, according to various embodiments. In particular, the relay 250 may include one or more component computing systems 255 that determine a destination and/or a routing for each encoded capture received from the transmitter system 230 and/or another relay 250. For example, a destination may include a client system 130 and a routing may include a sequence of one or more other relays 250 that connect the relay 250 to a destination client system 130. In further embodiments, the relay 250 may include an operation management server that routes encoded captures to one or more component computing systems 255 of the relay 250 for processing. The component computing systems 255 may process the encoded captures, read an appended destination and/or routing associated with each encoded capture, and further deliver the encoded capture to an I/O system for transmission to another external system and/or destination client system 130 specified by the routing. In various embodiments, one or more component computing systems 255 of the relay 250 may malfunction. In particular, a component computing system 255-f may not process or improperly process encoded captures, thereby causing the encoded captures to be mis-routed and/or otherwise not delivered to an appropriate client system 130.

In various embodiments, if a component computing system 255-f malfunctions, then the operation management server may identify an alternative component computing system 255-a to assume the processing steps of the malfunctioning component computing system 255-f. For example, the operation management server may identify a component computing system 255-a that is in an off state or an idle state. A component computing system 255-a may be in an off state during extended intervals between processing encoded captures, while the component computing system 255-a may be in an idle state during temporary time intervals between processing encoded captures. If the component computing system 255-a is in an off state or an idle state, the operation management server may transmit a notification to the component computing system 255-a that configures the component computing system 255-a to transition to an on state. In the on state, a component computing system 255-a may receive encoded captures from the operation management server and further process the encoded captures (e.g., determining a destination and/or a routing for the encoded capture). In particular, the operation management server may route encoded captures from the malfunctioning component computing system 255-f to the alternative component computing system 255-a. The alternative component computing system 255-a may further process the received encoded capture and deliver the processed capture to an I/O system of the relay 250 for output to another external system and/or a client system 130.

In various embodiments, one or more encoded captures may be encrypted. Accordingly, a private access key may be transmitted to each client systems 130 that is designated to receive an encrypted encoded capture. In various embodiments, the private access key may be transmitted by the transmitter system 230 directly to each client system 130. In various embodiments, each client system 130 designated to receive an encrypted encoded capture may receive a unique private access key. The client system 130 may decrypt the encrypted encoded capture using the private access key. In various embodiments, the private access key may be transmitted to each client system 130 using secure connection. In particular embodiments, encrypted encoded captures may be transmitted to client systems 130 connected directly to a transmitter system 230, while client systems 130 connected to a relay 250 may receive unencrypted captures over a secure connection (e.g., over a HTTPS connection).

In various embodiments, a core server 240 may transmit a notification to a client system 130. The notification may indicate a time to connect to an alternative system, such as an alternative relay 250-a, an alternative core server 240-a, and alternative transmitter system 230-a, and so forth. The notification may also indicate an address of the alternative system (e.g., a HTTPS URL). In various embodiments, one or more of a relay 250, a core server 240, a transmitter system 230, a streamer system 205, and so forth may generate and/or transmit the notification to the client system 130. The client system 130 may further connect to the alternative system at the time indicated in the notification using the address designated in the notification. Connecting to the alternative system enables encoded captures generated by the streamer system 205 to be transmitted to the client system 130. Accordingly, the client system 130 may reset a connection to the streamer system 205 caused by a system failure (e.g., a core server 240 failure) without user intervention. In particular, the client system 130 may automatically restore connection to the streamer system 205 via an alternative system by establishing a connection with the alternative system using the address provided in a received notification at a time designated in the received notification.

In various embodiments, as described above, a component computing system 255 may malfunction. The component computing system 255 may be part of a system, such as a relay 250, a core server 240, a transmitter system 230, an encoder system 220, and so forth. In particular, an operation management server of the system may re-route input data (e.g., high bitrate data, encoded captures, etc.) to an alternative component computing system 255. In various embodiments, there may be no available component computing systems 255 for transferring the processing tasks of the malfunctioning component computing system 255. Accordingly, in such embodiments, the system may generate a request for another system to take over the processing of the input data. For example, the relay 250 may generate a notification to a core server 240 that request that the input data be re-routed to an alternative system. Similarly, an encoder system 220 may generate a notification that request that the capture system re-route one or more captures streams from processes to an alternative encoder system 220. Accordingly, the system may generate a notification that requests that input data from one or more processes be re-routed to an alternative system. In particular another system may receive the request and further implement the above steps to identify an alternative system and further re-routed the input data to the alternative system. Similarly, the system may generate a notification to any down steam systems to establish a connection with the alternative system and to further receive processed data (e.g., encoded captures) from the alternative system.

In various embodiments, implementing the system 200 to facilitate the transfer of encoded captures from an external data source (e.g., the streaming system 205) to one or more client systems may provide various benefits. In particular, the system 200 may provide advantages over implementing direct connection between the streaming system 205 and each client system, such as, and not by way of limitation, reducing the cost of transferring encoded captures to client systems.

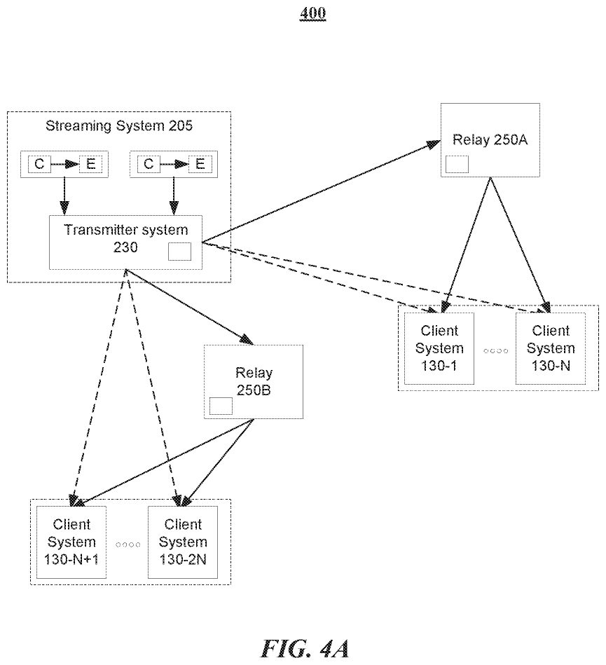

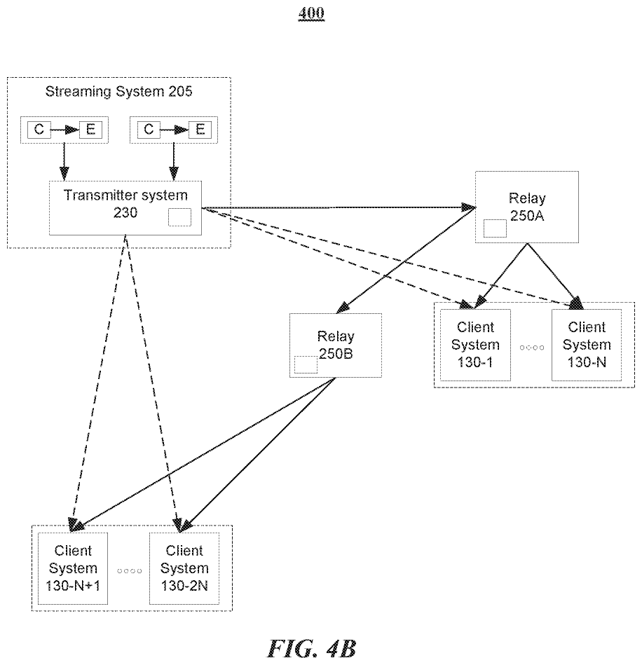

FIGS. 4A-4B illustrate cost comparisons between establishing direct connections between one or more client systems 130 and the streamer system 205 (solid lines) and implementing the system 400 to transfer encode captures to each client system 130 via one or more relays 250 (dashed lines). As explained herein, a transmitter may be providing streams directly to one or more client devices while also provide streams to one or more relays. In particular embodiments, a particular transmitter computing system 235 of transmitter 230 may provide a stream directly to one or more computing devices while also provide a stream to one or more relays.

In particular, FIG. 4A illustrates a parallel distribution from relays 250A-B. FIG. 4B illustrates distribution from a serial connection between relays 250A-B. In particular, the relay 250A provides encoded captures to client system 130-1 through client system 130-N, while the relay 250B provides encoded captures from the streaming system 205 to client system 130-N+1 through client system 130-2N.

In various embodiments, a fixed or variable cost may be associated with each encoded capture transferred from the streaming system 205 to one or more elements of the transfer system 207, for example, and not by way of limitation, the client systems 130, relays 250, and core servers 240. A cost may be assessed by the streaming system 205 for transmitting captures to client system 130. For example, and not by way of limitation, a cost may be assessed by the streamer system 205 based on a number of captures transmitted to the transfer system 207 and/or client systems 130, a number of connections between the streamer system 205 and elements of the transfer system 207 and client systems 130, an amount of time in which each connection is established and/or that captures are transmitted to the transfer system 207 and/or client systems 130, and so forth.

For example, and not by way of limitation, a fixed fee may be assessed by the streaming system 205 for each connection to an element of the transfer system 207 and/or client system 130. Accordingly, when direct connections between the streaming system 205 and each client system 130 (e.g., dashed lines) are established, the cost of data transfer may be computed as a number of connections to each of the client systems 130 (i.e., 2N) times the fixed fee. In particular, if the fixed fee is X, then the cost of direct connections is X times the number of connections, or 2N. Accordingly, the total cost may be computed as 2NX.

As stated above, FIG. 4A illustrates a parallel distribution from relays 250A-B.

As described above, there may be a cost associated with a direct connection between components of the streaming system. In addition, in various embodiments, there may also be cost associated with each connection between elements of the system 400. For example, there may be costs associated with data from a direct connection between the transmitter 230 and the client systems 130 or relay 250 (herein referred to as GS). There may also be a cost associated with a direct connect connection between the relay 250 and a client system 130 (herein referred to as RS). In various embodiments, the cost of data over directed connections from the streaming system 205 (e.g., GS) may be more than the cost of data over connections from relay server 250.

FIG. 4B illustrates the system 400 in a serial configuration, according to various embodiments. In particular, there may be direct connections between the streaming system 205 and relay 250A, which is directly connected to relay 250B.

The above examples of the system 400 are just some examples of the embodiments described herein. More or fewer relays 250 may be implemented by the re-steamer system 400. Additionally, or alternatively, the system 400 may receive data from one or more streaming system 205 and/or other external data sources. In addition, the system 400 may deliver encoded captures to more or fewer client systems 130. In addition, the cost of each data connection between elements of the streamer system 205, the transfer system 207, and the client systems 130 may be greater or less than the above-referenced cost distribution. In addition, the cost of each data connection may vary based on the type of data being transferred, type of connection established between each connecting device, a bandwidth limitation of the systems included in the data connection, and so forth.

In various embodiments, as a number of client systems 130 serviced by the system 400 increases, an amount of cost savings also increases relative to direct connections GS. In various embodiments, as a number of GS connections increases, the total cost may prove inhibitive for some users of client systems 130 and/or a number of client systems 130 requesting connection to the streaming system 205 may exceed a bandwidth limitation of the streaming system 205.

Accordingly, the streaming system 205 may reduce a cost associated with providing encoded captures to each client system 130. Additionally, or alternatively, the streaming system 205 may enable a greater number of client systems 130 to receive encoded captures from the streaming system 205. For example, if the streaming system 205 may only establish a limited number of direct connections with external systems (e.g., client systems 130), then implementing the streaming system 205 may increase the number of client systems 130 that can receive captures from the streamer system 205 relative to direct connection of each client system 130 to the streamer system 205.

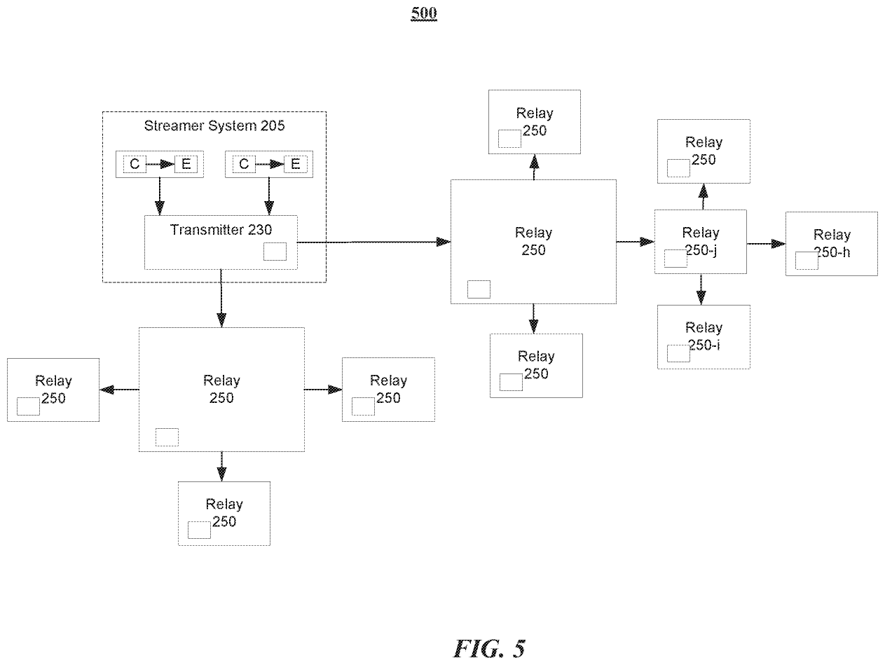

FIG. 5 illustrates an example scaling technique for the system 500, according to various embodiments. In particular, system environment 500 includes a streaming system 205, one or more core servers 240 and one or more relays 250 for routing encoded captures to client systems 130. In various embodiments, the relays 250 may facilitate the transfer of encoded captures from the streaming system 205 to one or more client systems 130. For example, and not by way of limitation, the streaming system 205 may transfer an encoded capture to a relay 250, the relay 250 may transfer the encoded capture directly to one or more client systems 130. In addition, a relay may transfer the encoded captures to one or more connected relays 250. The relays 250 may further transmit the encoded captures to one or more client systems 130 associated with the relay 250. Those relays 250 may further transmit the encoded captures to subsequent relays 250 and/or may transmit the encoded captures to one or more client systems 130. In various embodiments, encoded captures may be routed to one or more relays 250 located proximate to a target client system 130. The proximate relay 250 may further transmit the encoded capture to a destination client system(s) 130.

In various embodiments, as a number of client systems 130 requesting a connection the streaming system 205 increases, the system 500 may increase a number of relays 250 implemented in transferring encoded captures from the streaming system 205 to each client system 130. In particular, as described with respect to FIG. 2, when a relay 250 receives a connection request from a client system 130 that exceeds a number of client systems 130 supported by that relay, then the relay 250 may generate a request to a relay 250 to transmit encoded captures to the relay 250. In particular, the relay 250 may generate a directed connection with the streaming system 205. Additionally, or alternatively, the relay 250 may establish a connection with the requesting relay 250. The new relay 250 may receive encoded captures via the connection and further establish a connection with the requesting client system 130. The new relay 250 further transmits the received encoded capture to the requesting client system 130 via the client system connection.

In various embodiments, the system 500 may implement a branching configuration as illustrated in FIG. 5. In particular, implementing a branching configuration may reduce latency in transferring captures from streaming system 205 and client systems 130. For example, and not by way of limitation, implementing the branching technique may enable client systems 130 connected to relays 250 at the extremity of system environment 500 to be connected to the streaming system 205 via a reduced number of connections relative to a serial arrangement of relays 250. In particular, due to the larger number of connections, serial configurations of relays may increase latency as well as increase the susceptibility of the system 500 to crashes.

In addition, the branching configuration of the system 500 may prove less susceptible to failures due to system crashes relative to serial configurations. For example, and not by way of limitation, if an extrema relay 250-i of the system 500 exhibits system failure, then client systems 130 downstream of the relay 250-i may lose connection streaming system 205. However, client systems 130 that are located along a different branch of the system 500 may be unaffected by the malfunction of extrema relay 250-i. Accordingly, implementing the branching configuration of the system 500 may limit a number of client systems 130 that lose connection to the streaming system 205 due to system malfunctions.

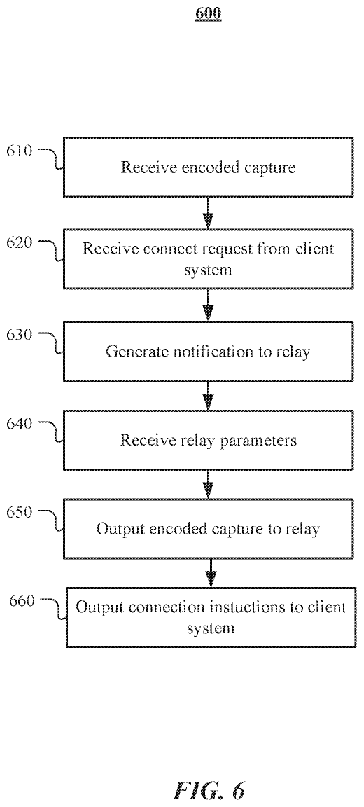

FIG. 6 illustrates an example method 600 for adding a relay to the system 200, according to various embodiments. The method 600 may begin at step 610, where one or more elements of the transfer system 207 may receive an encoded capture. For example, a relay 250 may receive an encoded capture. In various embodiments, the element of the transfer system 207 may receive a connect request from a client system 130. In various embodiments, the client system 130 may exceed the threshold number of client systems 130 supported by the element of the transfer system 207. Accordingly, in step 630, the element of the transfer system 207 may generate a notification to a relay 250 to route transfers to the requesting client system 130.

In step 640, element of the transfer system 207 may receive one or more parameters from the relay 250. For example, the relay may transmit a number of processes supported and/or a number of client systems 130 supported per process. In step 650, the element of the transfer system 207 may output one or more encoded captures to the relay for transmission to the requesting client system 130. In step 660, the relay may output the received encoded captures to the client system 130.

In various embodiments, the relay 250 may establish a connection with the client system 130. For example, and not by way of limitation, the core server 240 may transmit a notification to the client system 130 indicating a HTTPS URL address at which to access the relay 250. Furthermore, the relay 250 may receive encoded captures directly from the streaming system 205.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for adding a relay to the system 200 including the particular steps of the method of FIG. 6, this disclosure contemplates any suitable method for adding a relay to the system 200 including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

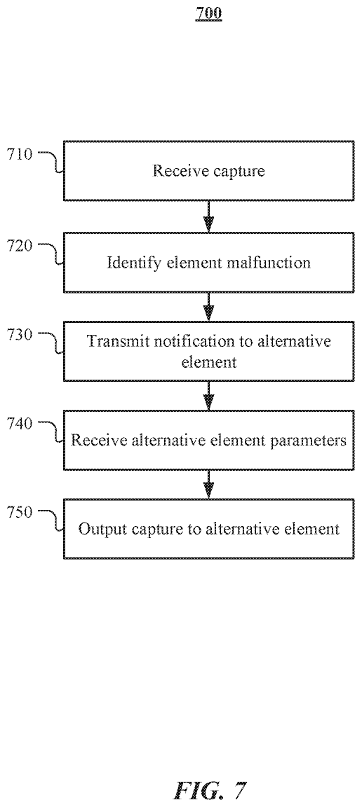

FIG. 7 illustrates an example method 700 for resolving element malfunctions in the system 200, according to various embodiments. The method 700 may begin at step 710, where one or more elements of the transfer system 207 may receive a capture. For example, the encoder system 220 may receive a capture. At step 720, the system 200 may identify a malfunction. For example, a transmitter system 230-f may malfunction. At step 730, the system 200 transmits a notification to an alternative element. For example, and not by way of limitation, the encoder system 220 may transmit a request to an alternative transmitter 230-a. In step 740, the system 200 receives element parameters. For example, the encoder system 220 may receive a number of processes supported by the alternative transmitter system 230-a.

In step 750, the system 200 outputs the capture to the alternative element. For example, the encoder system 220 outputs an encoded capture to the alternative transmitter system 230-a. In various embodiments, the system 200 may further transmit a notification to one or more system elements (e.g., the client system 130) to connect to the alternative element. For example, the notification may include one or more system parameters of the alternative element and/or and address of the element (e.g., a HTTPS URL address).

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for performing mesh simplification including the particular steps of the method of FIG. 7, this disclosure contemplates any suitable method for performing mesh simplification including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

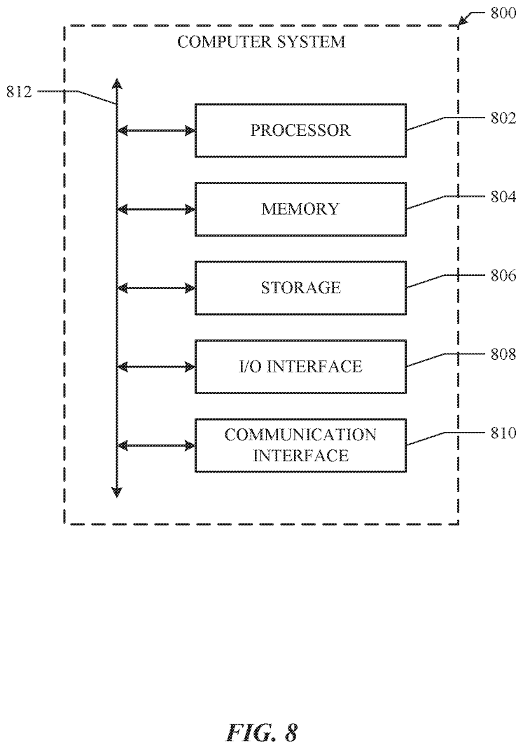

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, comprising:
receiving, by one or more computing systems, an encoded capture from a streaming system;
receiving a connection request from a client system;
determining that the client system exceeds a client system threshold;
outputting a streaming request to a relay;
receiving one or more relay parameters; and
transmitting the encoded capture to the relay, wherein the relay transmits the encoded capture to the client system.

2. The method of claim 1, further comprising transmitting the one or more relay parameters to the client system.

3. The method of claim 2, wherein the one or more relay parameters comprises an address for the relay, a number of processes supported by the relay, and a number of client systems supported per process.

4. The method of claim 1, further comprising determining that the relay, or a component of the relay has failed.

5. The method of claim 4, further comprising:
identifying a second relay to handle the encoded capture; and
re-route encoded capture to the client device via the second relay.

6. The method of claim 4, further comprising determining that the component of the relay that has failed when the component of the relay has caused the encoded capture to be mis-routed or not delivered to the client system.

7. The method of claim 1, wherein the encoded capture is encrypted, the method further comprising transmitting a private access key to the client system that the client device is to use to decrypt the encrypted encoded capture.

8. A method, comprising:
receiving, by one or more computing systems, a media item capture;
identifying an element malfunction of an element of the computing system;
transmitting a request to an alternative element;
receiving one or more parameters of the alternative element; and
outputting the capture to the alternative element.

9. The method of claim 8, wherein the element comprises one or more of a capture system, an encoder system, a transmitter system, a core server, a relay, and a component computing system.

10. The method of claim 8, wherein the one or more parameters comprises an address for the alternative element, a number of processes supported by the alternative element.

11. The method of claim 10, further comprising transmitting the one or more parameters to a client system.

12. The method of claim 11, wherein the one or more parameters further comprises a time to connect to the alternative element and a number of client systems supported by the alternative element.

13. The method of claim 8, further comprising:
determining that there are no available elements of the computing systems in which to transfer processing tasks of the malfunctioning elements of the computing system;
generating a request for another system to take over the processing of the media item capture; and
responsive to receiving an acceptance of the request from the another system to take over the processing of the media item capture, causing the another system to take over the processing of the media item capture.

14. A system, comprising:
a memory; and
one or more processors coupled to the memory, the one or more processors configured to execute operations that cause the system to perform operations comprising:
receive an encoded capture from a streaming system;
receive a connection request from a client system;
determine that the client system exceeds a client system threshold;
output a streaming request to a relay;
receive one or more relay parameters; and
transmit the encoded capture to the relay, wherein the relay transmits the encoded capture to the client system.

15. The system of claim 14, the operations further comprising transmitting the one or more relay parameters to the client system.

16. The system of claim 15, wherein the one or more relay parameters comprises an address for the relay, a number of processes supported by the relay, and a number of client systems supported per process.

17. The system of claim 1, the operations further comprising determining that the relay, or a component of the relay has failed.

18. The system of claim 17, the operations further comprising:
identifying a second relay to handle the encoded capture; and
re-route encoded capture to the client device via the second relay.

19. The system of claim 17, the operations further comprising determining that the component of the relay that has failed when the component of the relay has caused the encoded capture to be mis-routed or not delivered to the client system.

20. The system of claim 14, wherein the encoded capture is encrypted, the operations further comprising transmitting a private access key to the client system that the client device is to use to decrypt the encrypted encoded capture.
